(19) United States
(12) Patent Application Publication
(10) Pub. No.: US 2025/0244783 A1
(43) Pub. Date: Jul. 31, 2025

(54) Source Follower Type Regulator with DAC feedback

(71) Applicant: Cypress Semiconductor Corporation, San Jose, CA (US)

(72) Inventors: Erhan HANCIOGLU, Shoreline, WA (US); Revanth BELLAMKONDA, Cork (IE); Rajiv Singh, Bothell, WA (US); Anil Kumar PANARIYA, Cork (IE); Mudasir BASHIR, Lynnwood, WA (US); Eric MANN, Sammamish, WA (US)

(73) Assignee: Cypress Semiconductor Corporation, San Jose, CA (US)

(21) Appl. No.: 18/428,356

(22) Filed: Jan. 31, 2024

(51) Int. Cl. G05F 1/575

(52) U.S. Cl. CPC G05F 1/575

(57) ABSTRACT

Systems and methods are disclosed to measure output voltage of a source follower to control the reference voltage provided to the source follower to compensate for deviations of the output voltage from a desired operating range. Disclosed techniques include using an ADC or a window comparator to sample an output of a source follower type voltage regulator whose regulated voltage is set by a reference voltage. The sampled output voltage is compared against a desired range. The ADC or the window comparator generates an indication in response to the comparison. A processor or a sequencer may determine an adjustment amount to the reference voltage based on the indication and May 10 adjust the reference voltage based on the adjustment amount to maintain the output of the source follower type voltage regulator within the desired range. An ADC may apply the adjusted reference voltage to the source follower.

### TECHNICAL FIELD

This disclosure generally relates to power regulation for semiconductor devices,

and more specifically, to low dropout (LDO) voltage regulators that use an emitter follower with a feedback loop to provide the reference voltage for the emitter follower.

### BACKGROUND

Low dropout (LDO) regulators are DC linear voltage regulators that provide regulated voltages for a variety of applications. A LDO regulator generally consists of a power field effect transistor (FET) whose output voltage is regulated by an error amplifier. A first input of the error amplifier may provide a stable voltage reference and a second input of the error amplifier may monitor a fraction of the regulated output voltage through a resistive feedback network. When the output voltage deviates from the voltage reference, the error amplifier through the resistive network may provide the negative feedback to try to maintain a constant output voltage. The advantage of a LDO regulator is an output voltage that may be very close to the supply voltage (hence the name LDO), an absence of switching noise, and design simplicity. However, the error amplifier and the resistive network may be power hungry and may require significant area, which may limit embedding an LDO regulator in a semiconductor device to provide a regulated voltage for an IP block of the device or when used in mobile application. It is desirable to overcome these limitations.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a block diagram of a source follower based voltage regulator that uses an analog-to-digital converter (ADC) to measure the regulator output voltage and a digital-to-analog converter (DAC) to provide the reference voltage to the source follower based on the feedback from the ADC measurements in accordance with one aspect of the present disclosure.

FIG. 2 illustrates a block diagram of a source follower based voltage regulator that uses a window comparator to measure the regulator output voltage followed by digital control and a DAC to adjust the reference voltage of the source follower based on the measurements according to an embodiment.

FIG. 3 illustrates the values of the output from a window comparator resulting from comparisons of the regulator output voltage with a desired operating voltage range according to an embodiment.

FIG. 4 illustrates a block diagram of an ADC that includes a window comparator to quantize the output voltage of a source follower relative to a desired voltage range and a digital control component that uses the quantized output voltage to generate a digital feedback used to adjust the reference voltage of the source follower to regulate its output voltage according to an embodiment.

FIG. 5 illustrates a digital control component that receives quantized voltages of a source follower output to generate a feedback control signal and a DAC that uses the feedback control signal to adjust the reference voltage of the source follower to regulate its output voltage according to an embodiment.

FIG. 6A illustrates a digital frontend of a DAC that receives a digital control signal generated from quantized voltages of a source follower output to generate switch control signals used to a adjust the reference voltage of the source follower to regulate its output voltage according to an embodiment.

FIG. 6B illustrates an analog backend of a DAC that receives switch control signals generated by a digital frontend based on quantized voltages of a source follower output to adjust the reference voltage of the source follower to regulate its output voltage according to an embodiment.

FIG. 7A illustrates the output voltage waveform of a source follower based voltage regulator and a desired output voltage range according to an embodiment.

FIG. 7B illustrates the quantized output waveform of an ADC that uses a window comparator to compare the output voltage of the source follower with the desired output voltage range of FIG. 7A according to an embodiment.

FIG. 7C illustrates the waveform of the reference voltage of the source follower generated from a DAC and adjusted based on the quantized output waveform of FIG. 7B to regulate the source follower output voltage so that it stays within the desired output voltage range according to an embodiment.

FIG. 8 is a flow diagram illustrating a method for adjusting the reference voltage of a source follower based on a measurement of the source follower output voltage level to regulate the source follower output voltage according to an embodiment.

FIG. 9 is a flow diagram illustrating a method for adjusting the reference voltage of a source follower based on a comparison of the source follower output voltage with a desired output voltage range to regulate the source follower output voltage according to an embodiment.

FIG. 10 is a flow diagram illustrating a method for adjusting the reference voltage of a source follower based on measurements of consecutive samples of the source follower output voltage relative to a desired output voltage range to regulate the source follower output voltage according to an embodiment.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Source followers or common drain amplifiers are a type of field effect transistor (FET) amplifier characterized by a voltage gain of nearly unity, a very high input impedance and a very low output impedance. Because the voltage gain has low dependency on the output resistance load, source followers are highly suitable for use in voltage regulator applications to provide good load regulation. For example, the gate of an n-type junction FET (JFET) or an n-channel metal-oxide-semiconductor FET (MOSFET) may be connected to a voltage source (e.g., a reference voltage) to provide a low dropout regulated voltage to a load via the source terminal.

However, due to process and temperature variation, source follower voltage output may vary significantly, causing swings in the regulator output voltage. Described are systems and methods to measure the source follower output voltage to control the reference voltage provided to the source follower to compensate for deviations of the output voltage from a desired operating point. In one embodiment, a source follower type voltage regulator may use an ADC to measure the regulator output voltage and to feed the ADC measurements to a DAC to provide the reference voltage to the source follower. The feedback control loop may thus adjust the reference voltage to control the output voltage of the source follower type voltage regulator in response to temperature and process effect.

Voltage regulators are also usually required to be trimmed, which incurs production cost. To reduce cost, voltage regulator may be trimmed at a single temperature, with the result that the output voltage may vary with other temperatures. By using the ADC to make periodic measurements of the output voltage to compensate for the temperature effect, the disclosed techniques may reduce production cost of source follower based voltage regulators while ensuring a stable output voltage.

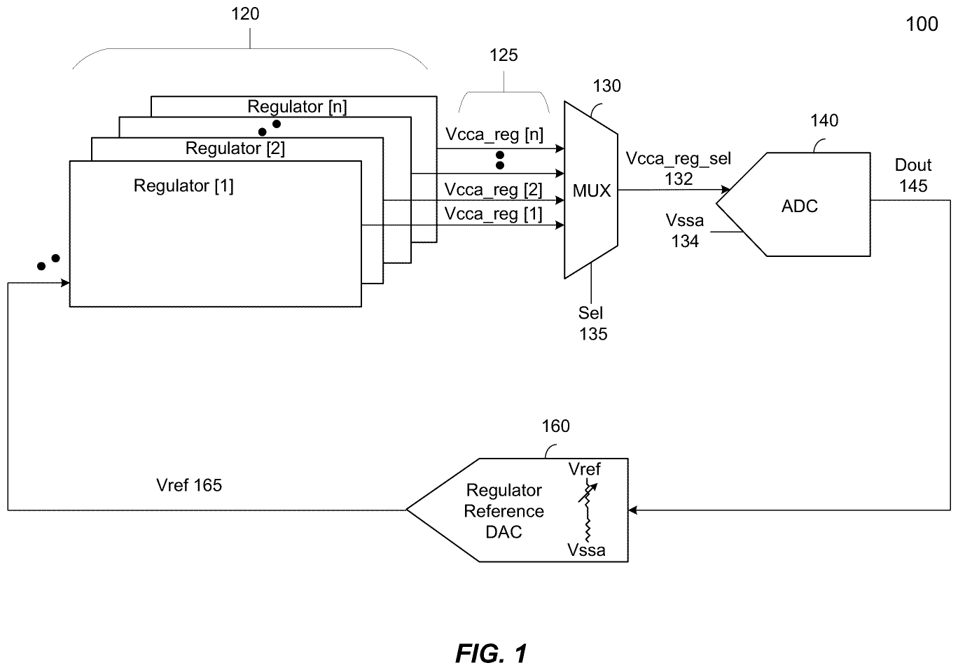

FIG. 1 illustrates a block diagram 100 of a source follower based voltage regulator that uses an analog-to-digital converter (ADC) to measure the regulator output voltage and a digital-to-analog converter (DAC) to provide the reference voltage to the source follower based on the feedback from the ADC measurements in accordance with one aspect of the present disclosure.

Output voltages from N source follower based voltage regulators [1, 2, . . . N] (120) are measured by an ADC 140 through a multiplexor 130. Each of the N regulators 120 may receive a respective reference voltage Vref 165 for setting its output voltage. The output voltages from the N regulators 120 follow their respective Vref 165 with a voltage gain close to unity and are denoted as Vcca_reg [1, 2, . . . N] (125). A processing device (e.g., microcontroller) or a sequencer may generate Sel 135 to control the multiplexor 130 to sequentially select one of the Vcca_reg [1, 2, . . . N] (125) to generate a selected output voltage Vcca_reg_sel 132 for quantization by the ADC 140.

The ADC 140 may quantize Vcca_reg_sel 132 to generate a quantized output Dout 145. The ADC 140 may have its own accurate voltage reference Vssa 134 provided by a bandgap reference (not shown). In one embodiment, the accuracy of Vssa 134 may be compensated for variation in temperature and other environmental factors. The ADC 140 may be a quantizer of various types, including those based on delta-sigma modulator, successive-approximation register, etc. In one embodiment, the ADC 140 may include a digital control component that operates on the output from the quantizer to generate Dout 145 that compensates for deviations of the Vcca_reg_sel 132 from a desired operating level or range. In one embodiment, the ADC 140 may include a decimator or a digital oversampling filter to generate Dout 145 of an appropriate width for the regulator reference DAC 160.

The regulator reference DAC 160 may generate the regulator reference voltage Vref 165 for the voltage regulator of the selected Vcca_reg_sel 132 based on Dout 145. The ADC 140 and the regulator reference DAC 160 constitute the control loop that sets the Vref 165 to maintain a stable output voltage Vcca_reg for each of source follower based voltage regulators [1, 2, . . . N] (120) across process and temperature variations. For example, when the output voltage Vcca_reg for a voltage regulator is more than the desired operating level or range, the control loop may decrease the Vref 165 for the voltage regulator to lower the Vcca_reg for the voltage regulator. On the other hand, when the output voltage Vcca_reg is less than the desired operating level or range, the control loop may increase the Vref 165 for the voltage regulator to raise the Vcca_reg. In one embodiment, the desired operating level or range for the N regulators 120 may be independently determined so that the Vref 165 for by the N regulators 120 are also independent. While FIG. 1 shows a single ADC 140 and a single regulator reference DAC 160 being time multiplexed among the N regulators 120 to adjust the Vref 165 for the different regulators, in other embodiments, a regulator may have its dedicated ADC and/or DAC in its control loop for the Vref 165.

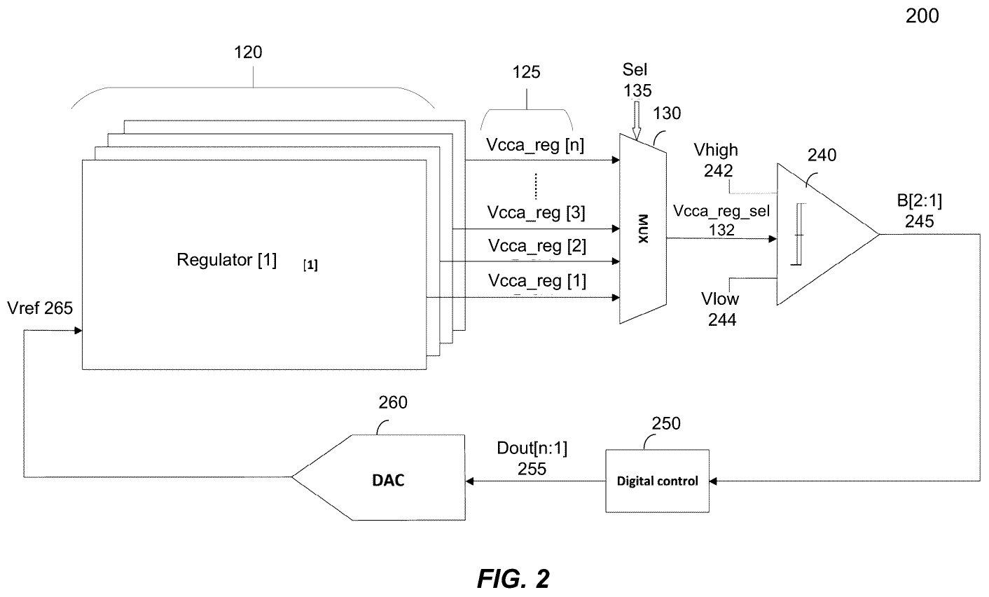

FIG. 2 illustrates a block diagram 200 of a source follower based voltage regulator that uses a window comparator to measure the regulator output voltage followed by digital control and a DAC to adjust the reference voltage of the source follower based on the measurements according to an embodiment.

Output voltages Vcca_reg [1, 2, . . . N] (125) from N source follower based voltage regulators [1, 2, . . . N] (120) are selected by a multiplexor 130 to generate Vcca_reg_sel 132 as described in FIG. 1. Each of the N regulators 120 may receive a respective reference voltage Vref 265 for setting its output voltage. A window comparator 240 may compare Vcca_reg_sel 132 to a desired operating voltage range delimited by Vhigh 242 and Vlow 244, where Vhigh 242 and Vlow 244 may define the upper boundary and the lower boundary of the desired operating voltage range, respectively. The window comparator 240 may generate an output B[2:1] 245 resulting from the comparison. In one embodiment, the window comparator 240 may measure Vcca_reg_sel 132 with a sampling interval to generate samples B[2:1] 245 at a certain period.

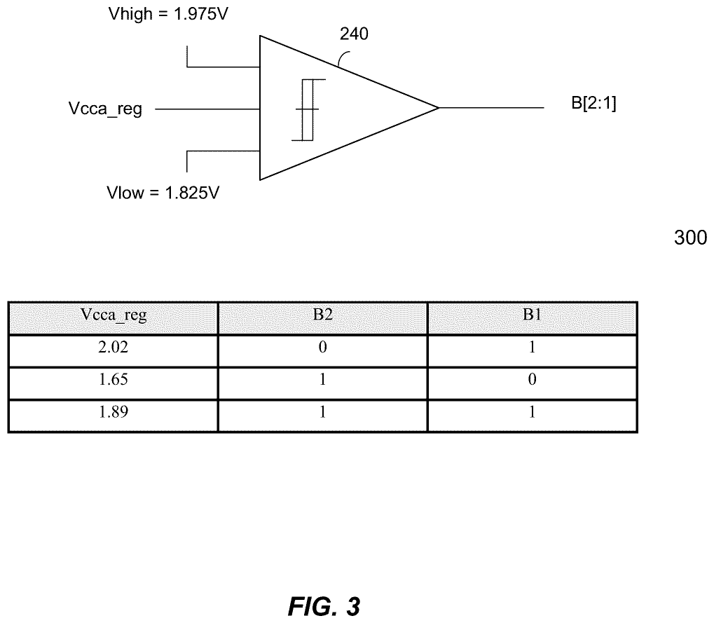

FIG. 3 illustrates the values of the output from the window comparator 240 resulting from comparisons of the regulator output voltage with a desired operating voltage range according to an embodiment.

The desired operating voltage range may be between 1.975V and 1.825V as determined by the Vhigh 242 and Vlow 244 of FIG. 2. The two-bit output from the window comparator 240 includes B2 and B1 as in B[2:1] 245 of FIG. 2. B2 is generated by a comparator that compares the Vcca_reg output of a regulator with 1.975V set by Vhigh 242. When Vcca_reg is less than 1.975V, B2 is 1; otherwise B2 is 0. B1 is generated by a comparator that compares Vcca_reg with 1.825V set by Vlow 244. When Vcca_reg is more than or equal to 1.825V, B1 is 1; otherwise B1 is 0. Table 300 shows the B[2:1] output from the window comparator 240 for three different values of Vcca_reg. When Vcca_reg is 1.65V and therefore less than the desired operating range, B[2:1] is 10. When Vcca_reg is 1.89V and therefore within the desired operating range, B[2:1] is 11. When Vcca_reg is 2.02V and therefore more than the desired operating range, B[2:1] is 01.

Referring back to FIG. 2, a digital control component 250 may receive B[2:1] 245 from the window comparator 240 to generate an N-bit control signal Dout[N:1] 255 to adjust the reference voltage of a selected regulator being monitored. The digital control components 250 may lower the current value of Dout[N:1] 255 by a delta when B[2:1] 245 indicates that Vcca_reg_sel 132 is more than Vhigh 242. On the other hand, the digital control components 250 may raise the current value of Dout[N:1] 255 by a delta when B[2:1] 245 indicates that Vcca_reg_sel 132 is less than Vlow 244. When B[2:1] 245 indicates that Vcca_reg_sel 132 is between Vhigh 242 and Vlow 244, digital control 250 may maintain the current value of Dout[N:1] 255.

In one embodiment, the digital control components 250 may change the delta used to adjust Dout[N:1] 255 based on a current sample of B[2:1] 245 and one or more immediately prior samples of B[2:1] 245. In this way, the digital control components 250 may change the slew rate by which the reference voltage for the selected regulator converges to the desired operating voltage range. In one embodiment, the digital control components 250 may be an N-bit up/down counter that increments or decrements based on B[2:1] 245 to generate Dout[N:1] 255.

A regulator reference DAC 260 may generate the regulator reference voltage Vref 265 for the voltage regulator of the selected Vcca_reg_sel 132 based on Dout[N:1] 255. The window comparator 240, the digital control component 250, and the DAC 260 constitute the control loop that adjusts the Vref 265 to maintain the output voltage Vcca_reg for each of the voltage regulators [1, 2, . . . N] (120) within the desired operating voltage determined by Vhigh 242 and Vlow 244 for the respective voltage regulator across process and temperature variations.

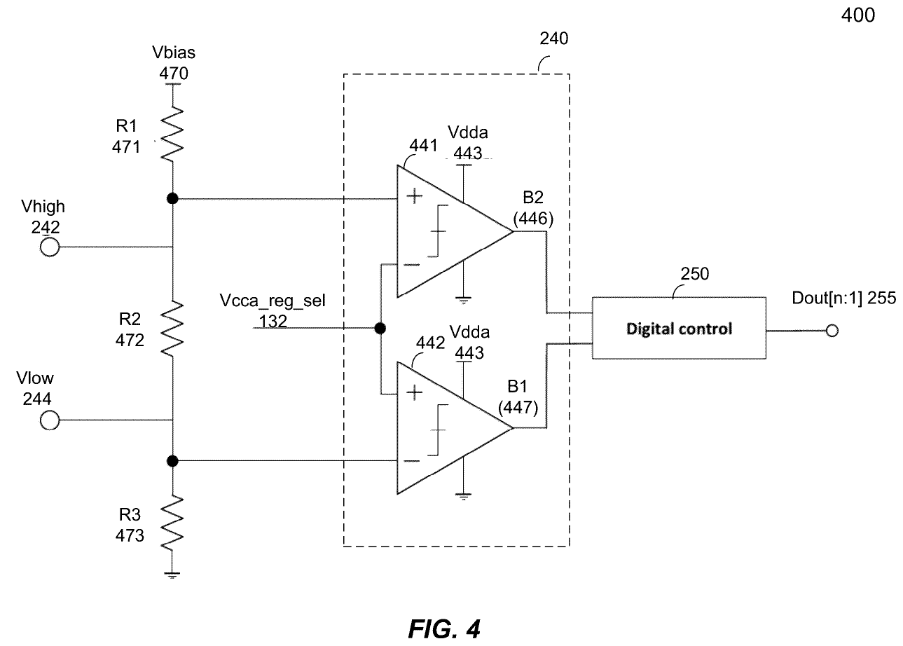

FIG. 4 illustrates a block diagram 400 of an ADC that includes a window comparator 240 to quantize the output voltage of a source follower relative to a desired voltage range and a digital control component 250 that uses the quantized output voltage to generate a digital feedback used to adjust the reference voltage of the source follower to regulate its output voltage according to an embodiment.

The window comparator 240 may compare the output voltage of a selected regulator (e.g., Vcca_reg_sel 132) against the desired operating voltage range as determined by Vhigh 242 and Vlow 244 as described for FIG. 3. The Vhigh 242 and Vlow 244 may be set by a voltage divider set by a resistive network of R1 471, R2 472, and R3 473 connected between Vbias 470 and ground. In one embodiment, a control circuit may change Vbias 470 to set different desired operating voltage ranges for different regulators.

The window comparator 240 may include two comparators 441 and 442. Comparator 441 may compare Vhigh 242 against Vcca_reg_sel 132 to generate voltage comparison output B2 446. As discussed for FIG. 3, when Vhigh 242 is higher than or equal to Vcca_reg_sel 132, B2 446 is high; otherwise, B2 446 is low. Comparator 442 may compare Vlow 244 against Vcca_reg_sel 132 to generate voltage comparison output B1 447. When Vcca_reg_sel 132 is higher than or equal to Vlow 244, B1 447 is high; otherwise, B1 447 is low. Comparators 441 and 442 may quantize Vcca_reg_sel 132 at a sampling frequency to generate periodic B2 446 and B2 447 samples.

The digital control component 250 may adjust Dout[N:1] 255 based on B2 446 and B2 447 as discussed for FIG. 2. The digital control component 250 may adjust Dout[N:1] 255 with a fixed or variable delta to increase or decrease Dout[N:1] 255 so as to maintain Vcca_reg_sel 132 between Vhigh 242 and Vlow 244.

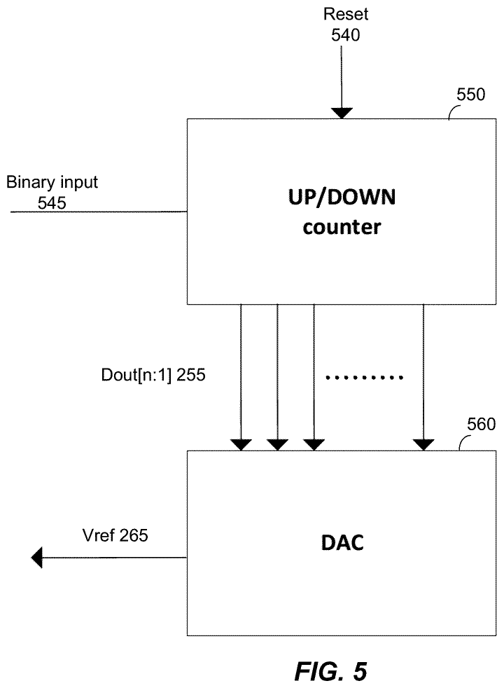

FIG. 5 illustrates a digital control component 550 that receives binary input 545 representing quantized voltages of a source follower output to generate a feedback control signal Dout[N:1] 255 and a DAC 560 that uses the feedback control signal Dout[N:1] 255 to adjust the reference voltage Vref 265 of the source follower to regulate its output voltage according to an embodiment. In one embodiment, digital control component 550 may be the digital control component 250 of FIG. 2 or FIG. 4.

The digital control component 550 may be an N-bit up/down counter that increments or decrements Dout[N:1] 255 based on the binary input 545. In one embodiment, the binary input 545 may be the B[2:1] 245 generated by the window comparator 240 of FIG. 2 or FIG. 3. For example, when the binary input 545 indicates that the output voltage of the source follower is more than a desired operating voltage range, the digital control component 550 may decrease Dout[N:1] 255 by a delta amount to drive down the output voltage toward the desired operating voltage range. On the other hand, when the binary input 545 indicates that the output voltage of the source follower is less than a desired operating voltage range, the digital control component 550 may increase Dout[N:1] 255 by a delta amount to drive up the output voltage toward the desired operating voltage range. In one embodiment, the delta amount by which the N-bit up/down counter adjusts Dout[N:1] 255 may be variable based on how binary input 545 changes in time in response to previous adjustments to Dout[N:1] 255 in the feedback control loop.

A processor or a sequencer may generate a reset 540 to initialize the N-bit up/down counter to a value that sets the output voltage of the source follower within the desired operating voltage before iterating the feedback control loop. In one embodiment, when the feedback control loops for multiple source followers time share the same ADC and DAC (e.g., window comparator 240 and DAC 260 of FIG. 2), the Dout[N:1] 255 for each source follower may be saved to memory. When the feedback control loop switches from operating on a first source follower to a second source follower, a processor or sequencer may save the current Dout[N:1] 255 of the first source follower in the N-bit up/down counter to the memory and may load the saved Dout[N:1] 255 of the second source follower from the memory into the N-bit up/down counter.

The DAC 560 may convert the Dout[N:1] 255 for a source follower to Vref 265 to adjust the reference voltage of the source follower to control its output voltage. In one embodiment, the DAC 560 may have a digital frontend and an analog backend.

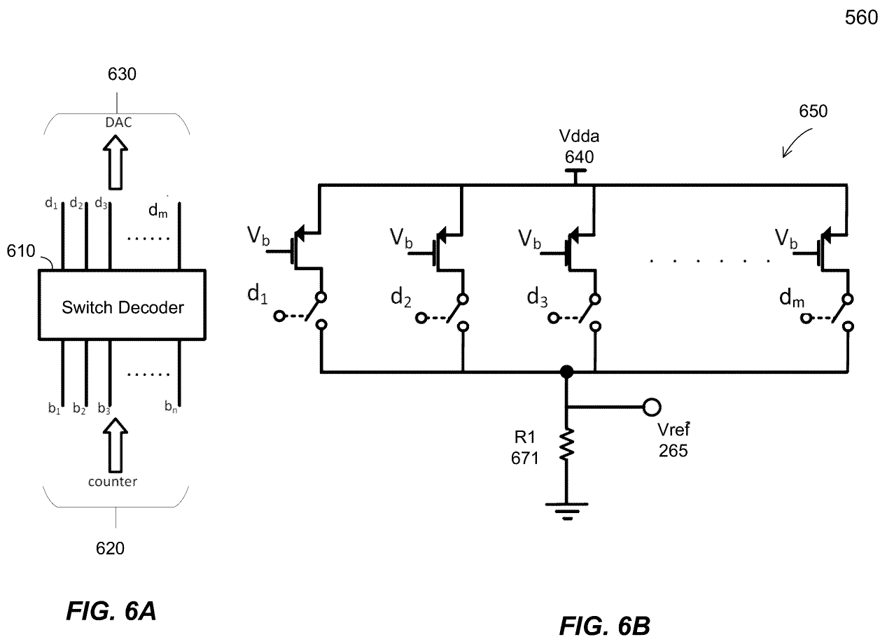

FIG. 6A illustrates a digital frontend 610 of a DAC 560 that receives a digital control signal B[N:1] 620 generated from quantized voltages of a source follower output to generate switch control signals D[M:1] 630 used to a adjust the reference voltage of the source follower to regulate its output voltage according to an embodiment. In one embodiment, DAC 560 may be the regulator reference DAC 160 of FIG. 1 or the DAC 260 of FIG. 2.

In one embodiment, the digital control signal B[N:1] 620 may be Dout[N:1] 255 from the N-bit up/down counter 550 of FIG. 5. The digital frontend 610 may be implemented as a switch decoder that converts B[N:1] 620 to the switch control signals D[M:1] 630 used by an analog backend 650 of the DAC 560 to generate the reference voltage Vref 265 of a source follower. In one embodiment, a monotonically increasing B[N:1] 620 (e.g., Dout[N:1] 255) may be decoded into a monotonically increasing D[M:1] 630.

FIG. 6B illustrates an analog backend 650 of the DAC 560 that receives switch control signals D[M:1] 630 generated by the digital frontend 610 based on quantized voltages of a source follower output to adjust the reference voltage Vref 265 of the source follower to regulate its output voltage according to an embodiment.

The analog backend 650 may be implemented as a bank of M current source transistors that are activated by the corresponding bit of the switch control signals D[M:1] 630. The bank of M current source transistors may be enabled at their respective gate terminal by a common voltage Vb. When a switch control signal bit of D[M:1] 630 is on, the corresponding switch is closed to allow current to flow from the source voltage Vdda 640 to ground via a load resistor R1 671. The voltage across the load resistor R1 671 may be used as the reference voltage Vref 265 of a source follower. As more bits of switch control signals D[M:1] 630 are turned on to activate more current source transistors, incrementally more current flows through the load resistor R1 671, resulting in a higher reference voltage Vref 265. In one embodiment, the M current source transistors may source different amounts of current to provide the DAC 560 with some flexibility in adjusting Vref 265. The next few figures illustrate using the window comparator 240, digital control component 250, and DAC 260 of FIG. 2 in a feedback control loop to adjust the Vref 265 of a source follower based voltage regulator.

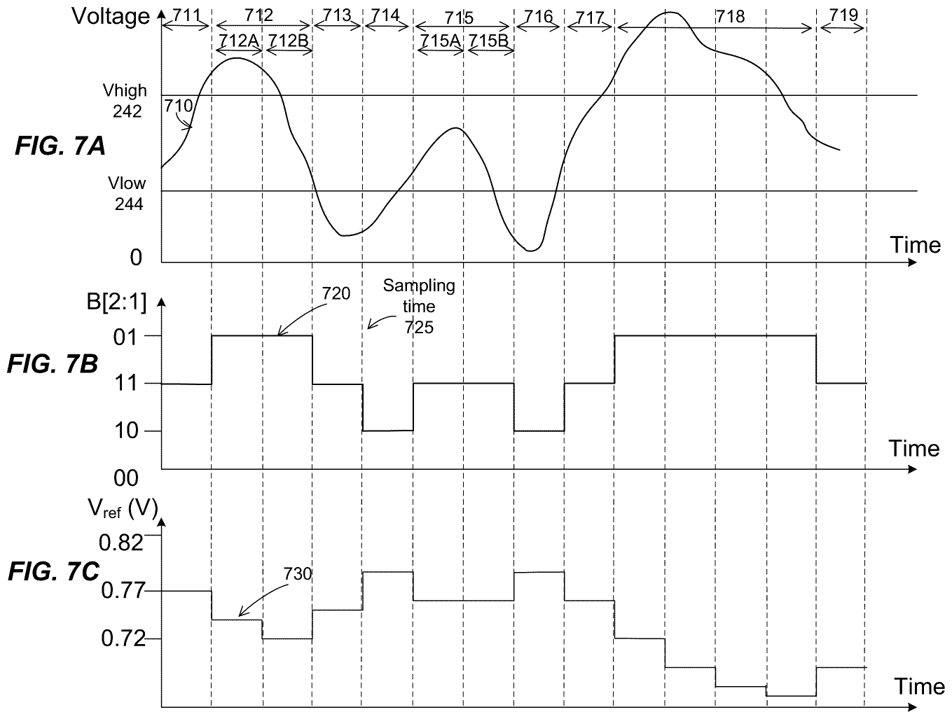

FIG. 7A illustrates the output voltage waveform 710 of a source follower based voltage regulator and a desired output voltage range according to an embodiment.

The desired output voltage range is between Vhigh 242 and Vlow 244. In one embodiment, the output voltage waveform 710 may be Vcca_reg_sel 132 to be compared against Vhigh 242 and Vlow 244 as shown in the window comparator 240 of FIG. 2. Due to temperature variation, the output voltage waveform 710 may fluctuate over time as shown.

FIG. 7B illustrates the quantized output waveform 720 of an ADC that uses the window comparator 240 to compare the output voltage of the source follower with the desired output voltage range of FIG. 7A according to an embodiment.

The window comparator 240 may operate as described in FIG. 4. The window comparator 240 may compare the output voltage waveform 710 with Vhigh 242 and Vlow 244 at periodic sampling time 725 to generate binary outputs B[2:1]. For example, during intervals 711, 713, 715, 717, and 719, the output voltage waveform 710 is between Vhigh 242 and Vlow 244 when sampled, resulting in the binary outputs B[2:1] of 11. During intervals 712 and 718, the output voltage waveform 710 is more than Vhigh 242, resulting in the binary outputs B[2:1] of 01. During intervals 714 and 716, the output voltage waveform 710 is less than Vlow 244, resulting in the binary outputs B[2:1] of 10.

FIG. 7C illustrates the waveform 730 of the reference voltage of the source follower generated from a DAC and adjusted based on the quantized output waveform of FIG. 7B to regulate the source follower output voltage so that it stays within the desired output voltage range according to an embodiment.

In one embodiment, the DAC 260 and the digital control component 250 of FIG. 2 may receive the binary outputs B[2:1] from the window comparator 240 to generate the reference voltage Vref 265. In one embodiment, the up/down counter of the digital control component 550 of FIG. 5 may receive the binary outputs B[2:1] to generate the Dout[N:1] 255 for the DAC 560 to generate Vref 265.

During interval 711, B[2:1] is 11, indicating that the output voltage waveform 710 is between Vhigh 242 and Vlow 244, and Vref is initially at 0.77V. During interval 712, B[2:1] becomes 01, indicating that the output voltage waveform 710 is higher than Vhigh 242. The DAC may decrease Vref to attempt to drive the output voltage 710 below Vhigh 242. Interval 712 may be decomposed into sub-intervals 712A and 712B. During sub-interval 712A, due to the lower Vref, the output voltage waveform 710 starts to decrease. However, the output voltage waveform 710 is still higher than Vhigh 242 at the next sampling instance, resulting in the binary outputs B[2:1] remaining at 01 during sub-interval 712B. The DAC may further decrease Vref as a result. In one embodiment, the amount of decrease in Vref in sub-intervals 712A and 712B may be different to account for the lag between the updating of Vref and the output voltage waveform 710 of the source follower changing in response to the updated Vref. For example, the digital control component 250/550 may detect that B[2:1] is at 01 in both sub-intervals 712A and 712B. The digital control component 250/550 may adjust the Dout[N:1] 255 to decrease the delta change in Vref during sub-intervals 712B compared to that of sub-interval 712A to avoid overcompensating the output voltage waveform 710.

During interval 713, B[2:1] becomes 11, indicating that the output voltage waveform 710 is now between Vhigh 242 and Vlow 244. The digital control component 250/550 may detect that B[2:1] has changed from 01 to 11. The digital control component 250/550 may increase Dout[N:1] 255 to raise Vref to avoid lowering the output voltage waveform 710 more than needed during interval 712, again to account for the lag between the updating Vref and detecting the output voltage waveform 710 changing in response to the updated Vref.

During interval 714, B[2:1] changes to 10, indicating that the output voltage waveform 710 has fallen lower than Vlow 244. The DAC may increase Vref to attempt to drive the output voltage 710 above Vlow 244.

During interval 715, B[2:1] becomes 11, indicating that the output voltage waveform 710 is now again between Vhigh 242 and Vlow 244. Interval 715 may be decomposed into sub-intervals 715A and 715B. During sub-interval 715A, the digital control component 250/550 may detect that B[2:1] has changed from 10 to 11. The digital control component 250/550 may decrease Dout[N:1] 255 to lower Vref to avoid raising the output voltage waveform 710 more than needed during interval 714, again to account for the lag between the updating Vref and detecting the output voltage waveform 710 changing in response to the updated Vref. During sub-interval 715B, the digital control component 250/550 may detect that B[2:1] remains 11 and may maintain Dout[N:1] 255 at its current level to keep Vref the same.

During interval 716, B[2:1] changes to 10, indicating that the output voltage waveform 710 has again fallen lower than Vlow 244. The DAC may increase Vref to attempt to drive the output voltage 710 above Vlow 244.

During interval 717, B[2:1] becomes 11, indicating that the output voltage waveform 710 is now again between Vhigh 242 and Vlow 244. During sub-interval 717, the digital control component 250/550 may detect that B[2:1] has changed from 10 to 11. The digital control component 250/550 may decrease Dout[N:1] 255 to lower Vref to avoid raising the output voltage waveform 710 more than needed during interval 716.

During interval 718, B[2:1] becomes 01, indicating that the output voltage waveform 710 has risen higher than Vhigh 242. The DAC may decrease Vref to attempt to drive the output voltage 710 below Vhigh 242. B[2:1] remains at 01 for four sampling intervals. The digital control component 250/550 may adjust the Dout[N:1] 255 to decrease the delta change in Vref during successive sampling intervals to avoid overcompensating the output voltage waveform 710.

During interval 719, B[2:1] becomes 11, indicating that the output voltage waveform 710 is now again between Vhigh 242 and Vlow 244. As in interval 713, the digital control component 250/550 may detect that B[2:1] has changed from 01 to 11. The digital control component 250/550 may increase Dout[N:1] 255 to raise Vref to avoid lowering the output voltage waveform 710 more than needed during interval 718.

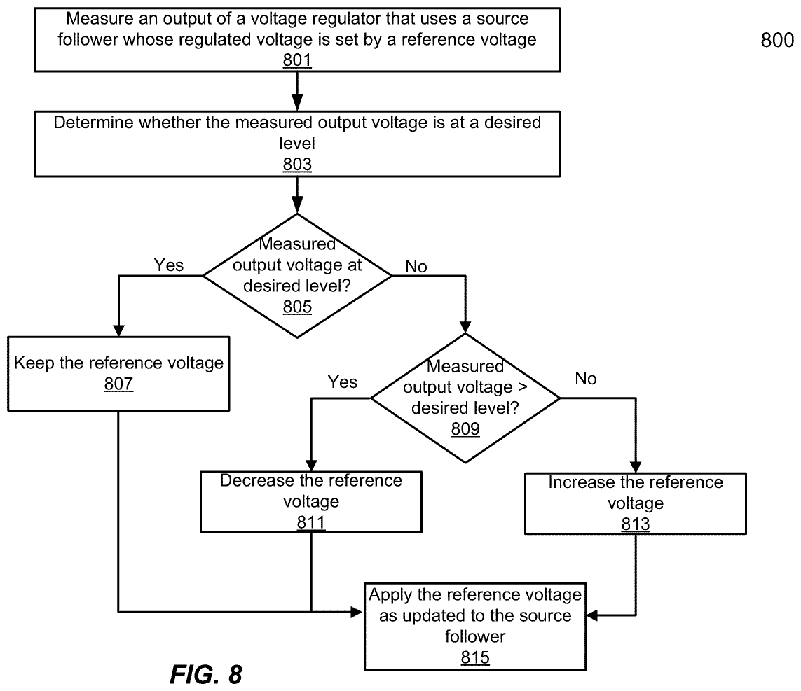

FIG. 8 is a flow diagram illustrating a method 800 for adjusting the reference voltage of a source follower based on a measurement of the source follower output voltage level to regulate the source follower output voltage according to an embodiment. Method 800 may be performed by a feedback control loop of FIG. 1 or 2 under control of a processor running software, a hardware sequencer, or a combination thereof.

In operation 801, method 800 measures an output of a voltage regulator that uses a source follower whose regulated voltage is set by a reference voltage. In one embodiment, operation 801 may measure the output of the voltage regulator using an ADC.

In operation 803, method 800 determines whether the measured output voltage is at a desired level. In operation 805, if the measured output voltage is at the desired level, operation 807 keeps the reference voltage. In operation 815, method 800 applies the reference voltage to the source follower.

Otherwise, if the measured output voltage is not at the desired level, operation 809 determines if the measured output voltage is more than the desired level. If the measured output voltage is more than the desired level, operation 811 decreases the reference voltage. In operation 815, method 800 applies the updated reference voltage to the source follower. In one embodiment, operation 815 may apply the updated reference voltage using a DAC.

If operation 809 determines that the measured output voltage is less than the desired level, operation 813 increases the reference voltage. In operation 815, method 800 applies the updated reference voltage to the source follower.

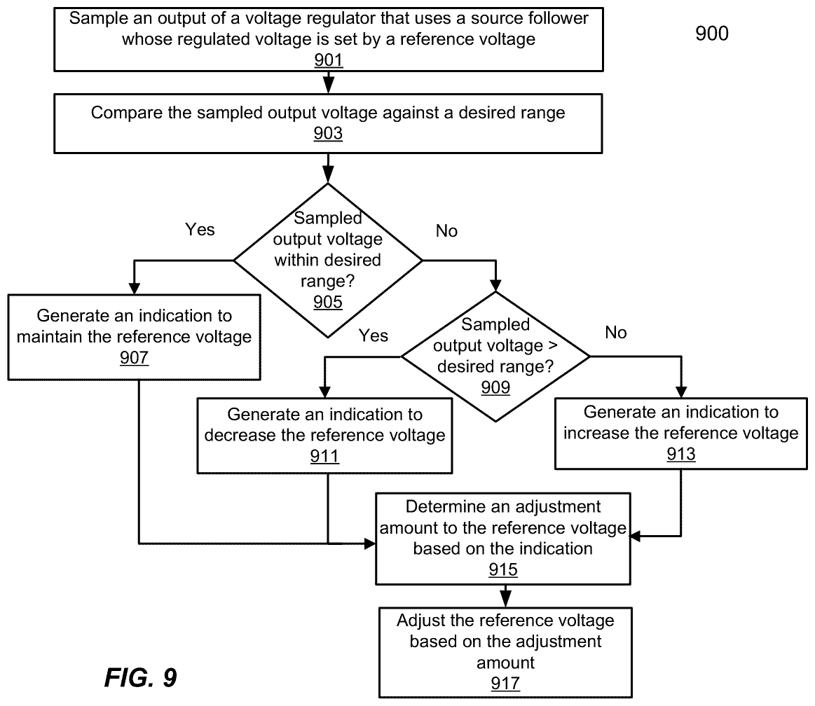

FIG. 9 is a flow diagram illustrating a method 900 for adjusting the reference voltage of a source follower based on a comparison of the source follower output voltage with a desired output voltage range to regulate the source follower output voltage according to an embodiment. Method 900 may be performed by a feedback control loop of FIG. 1 or 2 under control of a processor running software, a hardware sequencer, or a combination thereof.

In operation 901, method 900 samples an output of a voltage regulator that uses a

source follower whose regulated voltage is set by a reference voltage. In one embodiment, operation 901 may sample the output of the voltage regulator using a window comparator 240 of FIG. 2, 3, or 4.

In operation 903, method 900 compares the sampled output voltage against a desired range. In one embodiment, operation 903 may compare the sampled output voltage against a desired range using a window comparator 240 of FIG. 2, 3, or 4. In operation 905, if the sampled output voltage is within the desired range, operation 907 generates an indication to maintain the reference voltage. In one embodiment, the window comparator 240 may generate the binary output B[2:1] to indicate that the reference voltage is to be maintained.

Otherwise, if the sampled output voltage is not within the desired range, operation 909 determines if the sampled output voltage is greater than the desired range. If the sampled output voltage is greater than the desired range, operation 911 generates an indication to decrease the reference voltage. In one embodiment, the window comparator 240 may generate the binary output B[2:1] to indicate that the reference voltage is to be decreased.

If operation 909 determines that the sampled output voltage is less than the desired range, operation 913 generates an indication to increase the reference voltage. In one embodiment, the window comparator 240 may generate the binary output B[2:1] to indicate that the reference voltage is to be increased.

In operation 915, method 900 determines an adjustment amount to the reference voltage based on the indication from operation 907, 9111, or 913. In one embodiment, the digital control component 250 of FIGS. 2, 4 or the up/down counter 550 of FIG. 5 may generate Dout[N:1] 255 as an adjustment amount to the reference voltage based on the indication.

In operation 917, method 900 adjusts the reference voltage based on the adjustment amount. In one embodiment, the regulator reference DAC 160 of FIGS. 1, DAC 260 of FIG. 2, or the DAC 560 of FIG. 5 or 6 may adjust the reference voltage Vref based on the adjustment amount.

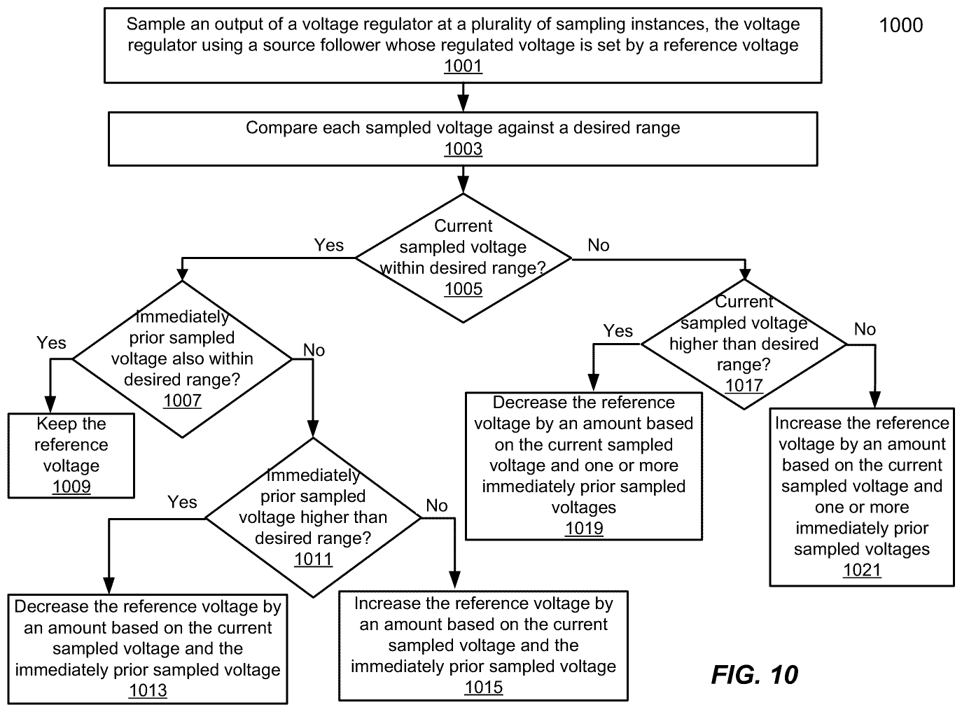

FIG. 10 is a flow diagram illustrating a method 1000 for adjusting the reference voltage of a source follower based on measurements of consecutive samples of the source follower output voltage relative to a desired output voltage range to regulate the source follower output voltage according to an embodiment. Method 1000 may be performed by a feedback control loop of FIG. 1 or 2 under control of a processor running software, a hardware sequencer, or a combination thereof.

In operation 1001, method 1000 samples an output of a voltage regulator at a plurality of sampling instances, the voltage regulator using a source follower whose regulated voltage is set by a reference voltage. In one embodiment, operation 1001 may sample the output of the voltage regulator using a window comparator 240 of FIG. 2, 3, or 4.

In operation 1003, method 1000 compares each sampled voltage against a desired range. In one embodiment, operation 1003 may compare each sampled voltage against a desired range using a window comparator 240 of FIG. 2, 3, or 4.

In operation 1005, if a current sampled voltage is within the desired range, operation 1007 determines if an immediately prior sampled voltage is also within the desired range. If the immediately prior sampled voltage is also within the desired range, operation 1009 keeps the reference voltage. In one embodiment, the digital control component 250 of FIGS. 2, 4 or the up/down counter 550 of FIG. 5 and the regulator reference DAC 160 of FIGS. 1, DAC 260 of FIG. 2, or the DAC 560 of FIG. 5 or 6 may implement operation 1009.

If the immediately prior sampled voltage is not within the desired range, operation 1011 determines if the immediately prior sampled voltage is higher than the desired range. If the immediately prior sampled voltage is higher than the desired range, operation 1013 decreases the reference voltage by an amount based on the current sampled voltage and the immediately prior sampled voltage. In one embodiment, operation 1013 may increase the reference voltage based on the current sampled voltage and the higher immediately-prior sampled voltage to avoid lowering the regulator output voltage too much during the last updating cycle in response to the higher immediately-prior sampled voltage due to the lag between updating the reference voltage and the regulator output voltage changing in response thereto, as noted in FIG. 7A-7C. In one embodiment, the digital control component 250 of FIGS. 2, 4 or the up/down counter 550 of FIG. 5 and the regulator reference DAC 160 of FIGS. 1, DAC 260 of FIG. 2, or the DAC 560 of FIG. 5 or 6 may implement operation 1013.

Otherwise, if the immediate prior sampled voltage is less than the desired range, operation 1015 increases the reference voltage by an amount based on the current sampled voltage and the immediately prior sampled voltage. In one embodiment, operation 1015 may decrease the reference voltage based on the current sampled voltage and the lower immediately-prior lower sampled voltage to avoid raising the regulator output voltage too much during the last updating cycle in response to the lower immediately-prior sampled voltage due to the lag between updating the reference voltage and the regulator output voltage changing in response thereto, as noted in FIG. 7A-7C. In one embodiment, the digital control component 250 of FIGS. 2, 4 or the up/down counter 550 of FIG. 5 and the regulator reference DAC 160 of FIGS. 1, DAC 260 of FIG. 2, or the DAC 560 of FIG. 5 or 6 may implement operation 1015.

If from operation 1005, the current sampled voltage is not within the desired range, operation 1017 determines if the current sampled voltage is higher than the desired range. If the current sampled voltage is higher than the desired range, operation 1019 decreases the reference voltage by an amount based on the current sampled voltage and one or more immediately prior sampled voltages. In one embodiment, the digital control component 250 of FIGS. 2, 4 or the up/down counter 550 of FIG. 5 and the regulator reference DAC 160 of FIGS. 1, DAC 260 of FIG. 2, or the DAC 560 of FIG. 5 or 6 may implement operation 1019.

Otherwise, if the current sampled voltage is less than the desired range, operation 1021 increases the reference voltage by an amount based on the current sampled voltage and one or more immediately prior sampled voltages. In one embodiment, the digital control component 250 of FIGS. 2, 4 or the up/down counter 550 of FIG. 5 and the regulator reference DAC 160 of FIGS. 1, DAC 260 of FIG. 2, or the DAC 560 of FIG. 5 or 6 may implement operation 1021.

A computer-readable medium used to implement operations of various aspects of the disclosure may be non-transitory computer-readable storage medium that may include, but is not limited to, electromagnetic storage medium, magneto-optical storage medium, read-only memory (ROM), random-access memory (RAM), erasable programmable memory (e.g., EPROM and EEPROM), flash memory, or another now-known or later- developed non-transitory type of medium that is suitable for storing configuration information.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “may include”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing. For example, certain operations may be performed, at least in part, in a reverse order, concurrently and/or in parallel with other operations.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware-for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component.

Additionally, “configured to” or “configurable to” can include generic structure (e.g., generic circuitry) that is manipulated by firmware (e.g., an FPGA) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method of voltage regulation, comprising:
sampling an output of a voltage regulator that is based on a source follower whose regulated voltage is set by a reference voltage to generate a sampled output voltage;
comparing the sampled output voltage against a desired range;
generating an indication in response to a result of comparing the sampled output voltage against the desired range;
determining an adjustment amount to the reference voltage based on the indication; and
adjusting the reference voltage based on the adjustment amount.

2. The method of claim 1, wherein the desired range is bounded by a high operating voltage and a low operating voltage.

3. The method of claim 1, wherein comparing the sampled output voltage against a desired range comprises:
determining whether the sampled output voltage is within the desired range;
determining whether the sampled output voltage is higher than the desired range; or
determining whether the sampled output voltage is lower than the desired range.

4. The method of claim 3, wherein generating an indication in response to a result of comparing the sampled output voltage against the desired range comprises:
generating the indication to keep the reference voltage in response to determining that the sampled output voltage is within the desired range;
generating the indication to decrease the reference voltage in response to determining that the sampled output voltage is higher than the desired range; or
generating the indication to increase the reference voltage in response to determining that the sampled output voltage is lower than the desired range.

5. The method of claim 1, wherein determining an adjustment amount to the reference voltage based on the indication comprises:
determining the adjustment amount to the reference voltage to maintain the output of the voltage regulator within the desired range.

6. The method of claim 1, wherein the desired range is a desired voltage level.

7. The method of claim 1, further comprising:
repeatedly sampling the output of the voltage regulator at a plurality of sampling instances, comparing the sampled output voltage against the desired range, generating an indication in response to the result of the comparing, determining an adjustment amount based to the reference voltage based on the indication, and adjusting the refence voltage based on the adjustment amount to maintain the output of the voltage regulator within the desired range.

8. The method of claim 7, wherein determining an adjustment amount to the reference voltage based on the indication comprises:
determining the adjustment amount to the reference voltage based on a plurality of indications generated in response to comparing a current sampled output voltage and one or more prior sampled output voltages against the desired range.

9. The method of claim 8, wherein successive adjustment amounts are variable when the plurality of indications indicate that the current sampled output voltage and the one or more prior sampled output voltages are all higher or lower than the desired range.

10. The method of claim 1, wherein adjusting the reference voltage based on the adjustment amount comprises:
incrementing or decrementing an up/down counter by the adjustment amount, wherein the up/down counter corresponds to a range of variation of the reference voltage.

11. An apparatus comprising:
a voltage comparator configured to:
sample an output of a voltage regulator that is based on a source follower whose regulated voltage is set by a reference voltage to generate a sampled output voltage;
compare the sampled output voltage against a desired range; and
generate an indication in response to a result of comparing the sampled output voltage against the desired range; and
a processor configured to perform operations, the operations comprising:
determine an adjustment amount to the reference voltage based on the indication; and
adjust the reference voltage based on the adjustment amount.

12. The apparatus of claim 11, wherein the desired range is bounded by a high operating voltage and a low operating voltage.

13. The apparatus of claim 11, wherein to compare the sampled output voltage against the desired range, the voltage comparator is configured to:
determine whether the sampled output voltage is within the desired range;
determine whether the sampled output voltage is higher than the desired range; or determine whether the sampled output voltage is lower than the desired range.

14. The apparatus of claim 13, wherein to generate the indication in response to a result of comparing the sampled output voltage against the desired range, the voltage comparator is configured to:
generate the indication to keep the reference voltage in response to determining that the sampled output voltage is within the desired range;
generate the indication to decrease the reference voltage in response to determining that the sampled output voltage is higher than the desired range; or
generate the indication to increase the reference voltage in response to determining that the sampled output voltage is lower than the desired range.

15. The apparatus of claim 11, wherein to determine the adjustment amount to the reference voltage based on the indication, the processor is further configured to perform operations comprising:
determine the adjustment amount to the reference voltage to maintain the output of the voltage regulator within the desired range.

16. The apparatus of claim 11, wherein the desired range is a desired voltage level.

17. The apparatus of claim 11, wherein the voltage comparator is further configured to:
repeatedly sample the output of the voltage regulator at a plurality of sampling instances, compare the sampled output voltage against the desired range, and generate an indication in response to the result of the comparing,
and wherein the processor is further configured to perform operations comprising:
repeatedly determine an adjustment amount to the reference voltage based on the indication and adjust the reference voltage based on the adjustment amount to maintain the output of the voltage regulator within the desired range.

18. The apparatus of claim 17, wherein to determine the adjustment amount to the reference voltage based on the indication, the processor is further configured to perform operations comprising:
determine the adjustment amount to the reference voltage based on a plurality of indications generated in response to comparing a current sampled output voltage and one or more prior sampled output voltages against the desired range.

19. The apparatus of claim 18, wherein successive adjustment amounts are variable when the plurality of indications indicate that the current sampled output voltage and the one or more prior sampled output voltages are all higher or lower than the desired range.

20. The apparatus of claim 11, wherein to adjust the reference voltage based on the adjustment amount, the processor is further configured to perform operations comprising:
increment or decrement an up/down counter by the adjustment amount, wherein the up/down counter corresponds to a range of variation of the reference voltage.
